(19) United States
(12) Patent Application Publication
(10) Pub. No.: US 2021/0298527 A1
(43) Pub. Date: Sep. 30, 2021

(54) ELECTRIC SKILLET

(71) Applicant: Rachel Peace, Sharpsville, IN (US)

(72) Inventor: Rachel Peace, Sharpsville, IN (US)

(21) Appl. No.: 16/830,715

(22) Filed: Mar. 26, 2020

(51) Int. Cl. A47J 37/10; A47J 37/12

(52) U.S. Cl. CPC A47J 37/105; A47J 37/108; A47J 37/1209

(57) ABSTRACT

An illustrated view of an exemplary electric skillet for cooking is presented. The electric skillet is useful for providing an easy, efficient and safe way to cook using the electric skillet. The electric skillet is useful for avoiding scratches and nicks which can cause a shortened lifespan of the skillet, avoid creating spaces for bacteria to grow and an easy removing of food and clean-up of the electric skillet. The electric skillet preferably has a square or oblong shape, however other shapes are hereby contemplated, including, but not limited to, round, rectangular, octagonal, etc.

### FIELD OF THE INVENTION

This invention relates to skillets. More particularly, it relates to electric skillets.

### BACKGROUND

A frying pan, frypan, or skillet is a flat-bottomed pan used for frying, searing, and browning foods. It is typically 200 to 300 mm (8 to 12 in) in diameter with relatively low sides that flare outwards, a long handle, and no lid. Larger pans may have a small grab handle opposite the main handle. A pan of similar dimensions, but with less flared vertical sides and often with a lid, is called a sauté pan. While a sauté pan can be used like a frying pan, it is designed for lower-heat cooking methods, namely sautéing.

A process for bonding Teflon to chemically roughened aluminum was patented in France by Marc Gregoire in 1954. In 1956 he formed a company to market non-stick cookware under the “Tefal®” brand name. The durability of the early coatings was initially poor, but improvements in manufacturing have made these products a kitchen standard. The surface is not as tough as metal and the use of metal utensils (e.g. spatulas) can permanently mar the coating and degrade its non-stick property.

For some cooking preparations a non-stick frying pan is inappropriate, especially for deglazing, where the residue of browning is to be incorporated in a later step such as a pan sauce. Since little or no residue can stick to the surface, the sauce will fail for lack of its primary flavoring agent.

Non-stick frying pans featuring Teflon coatings may give off toxic fumes, as the coating decomposes when heated beyond approximately 240° C. (464° F.). Such temperatures can be reached within minutes on gas or electric ranges using high heat.

An electric frying pan or electric skillet incorporates an electric heating element into the frying pan itself and so can function independently off of a cooking stove. Accordingly, it has heat-insulated legs for standing on a countertop. (The legs usually attach to handles.) Electric frying pans are common in shapes that are unusual for ‘unpowered’ frying pans, notably square and rectangular. Most are designed with straighter sides than their stovetop cousins and include a lid. In this way they are a cross between a frying pan and a sauté pan.

A modern electric skillet has an additional advantage over the stovetop version: heat regulation. The detachable power cord incorporates a thermostatic control for maintaining the desired temperature.

With the perfection of the thermostatic control, the electric skillet became a popular kitchen appliance. Although it largely has been supplanted by the microwave oven, it is still in use in many kitchens.

Although Teflon has improved the lifespan of the electric skillet, the electric skillet is still subject to nicks, scratches and the like which can cause food to stick to the skillet or build up of bacteria in the scratches and nicks. Further, current electric skillets are not efficient when pan frying and another type of pan or skillet must be used.

In light of the foregoing, there is a need for an electric skillet that will not scratch and nick thus cause sticking of food and bacterial growth. It is further a need that the electric skillet be useful for pan frying as well.

### BRIEF DESCRIPTION OF THE DRAWINGS

FIG. 1A is an illustrated view of an exemplary electric skillet.

FIG. 1B is an illustrated view of an open top of the electric skillet shown in FIG. 1A.

FIG. 1C is an illustrated view of components of the electric skillet shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

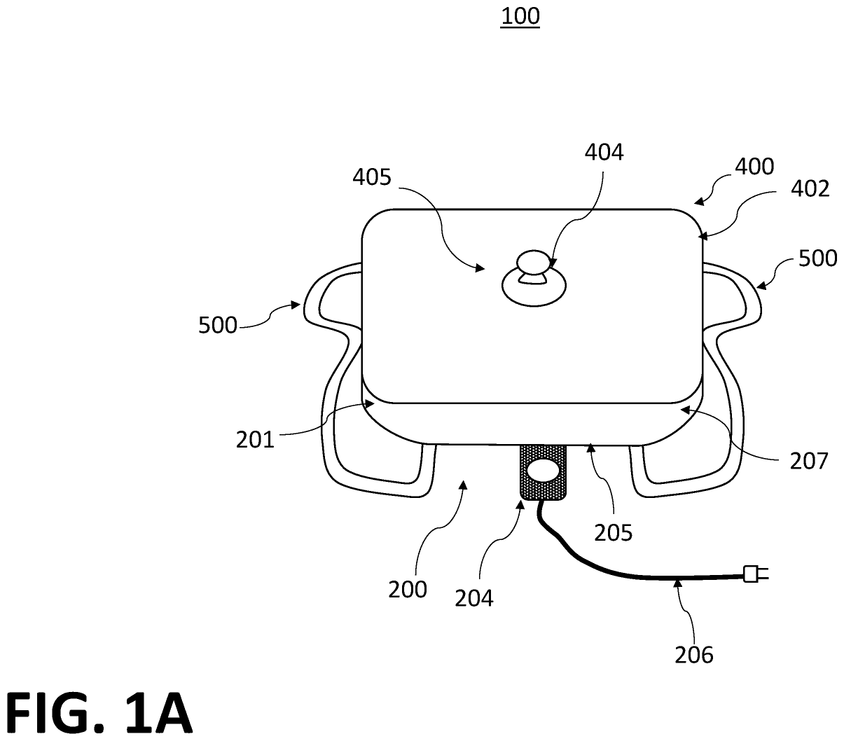

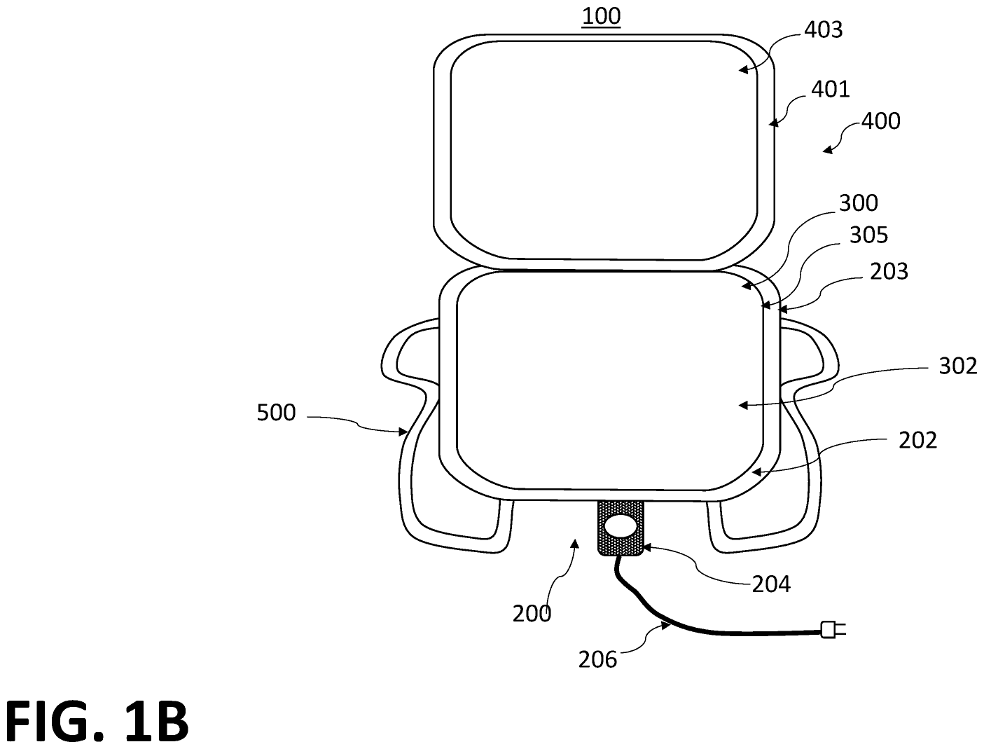

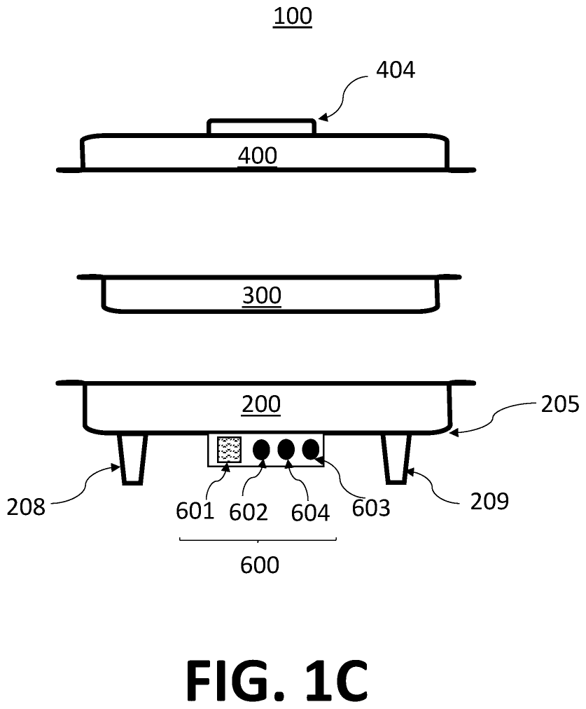

Referring to FIG. 1A, FIG. 1B and FIG. 1C, an illustrated view of an exemplary electric skillet 100 for cooking is presented. The electric skillet 100 is useful for providing an easy, efficient and safe way to cook using the electric skillet 100. The electric skillet 100 is useful for avoiding scratches and nicks which can cause a shortened lifespan of the skillet 100, avoid creating spaces for bacteria to grow and an easy removing of food and cleanup of the electric skillet 100.

The electric skillet 100 preferably has a square or oblong shape, however other shapes are hereby contemplated, including, but not limited to, round, rectangular, octagonal, etc. The electric skillet 100 preferably has a height of between four and five (4-5) inches, however other heights are hereby contemplated, including, but not limited to, three and one-half (3.5) inches, five and one-half (5.5) inches, etc. The electric skillet 100 preferably has a length of sixteen (16) inches, however other lengths are hereby contemplated, including, but not limited to, thirteen (13) inches, eighteen (18) inches, etc. the electric skillet 100 preferably has a width of twelve (12) inches, however other widths are hereby contemplated, including, but not limited to, ten (10) inches, fifteen (15) inches, etc.

The electric skillet 100 has an outer shell 200, a pan 300, one or more handles 500 and a top 400.

The outer shell 200 is preferably made of a cast iron material, however other materials are hereby contemplated, including, but not limited to, copper, aluminum, carbon steel, etc. The outer shell 200 has an outside 201, an inside 202 and a rim 203. An electric port 204 is coupled to substantially near a bottom 205 of the outside 201 of the outer shell 200. The electric port 204 is coupled to a power source by an electrical cord 206.

The pan 300 is preferably made of a ceramic material, however other types of materials are hereby contemplated, including, but not limited to, copper, aluminum, carbon steel, etc. The pan 300 has an outside 301, an inside 302 and a rim 305. The pan 300 is removably coupled to the inside 202 of the outer shell 200. The rim 305 of the pan 300 is removably coupled to the rim 203 of the outer surface 200.

The handles 500 are coupled to a middle portion 207 of the outer shell 200 of the electric skillet 100. The handles are preferably made of a heat-resistant plastic material, however other types of materials are hereby contemplated, including, but not limited to, aluminum, cooper, etc. The handles 500 are useful for transporting the electric skillet 100.

The top 400 has an edge 401, an outside 402, an inside 403 and top handle 404. The top 400 is preferably made of a cast iron material, however other materials are hereby contemplated, including, but not limited to, copper, aluminum, carbon steel, etc. The top handle 404 is preferably made of a heat-resistant plastic material, however other types of materials are hereby contemplated, including, but not limited to, aluminum, etc.

The top handle 404 is preferably coupled to a middle portion 405 of the outside 402 of the top 400. The top handle 404 is useful for lifting the top 400 from the outer shell 200 of the electric skillet 100. The top 400 is configured to be removably coupled to the outer shell 200.

When the top 400 is lifted from the outer shell 200, the inside 302 of the pan 300 is exposed to place food for cooking or to remove food that has been cooked in the electric skillet 100.

In FIG. 1C, the pan 300 is preferably removable. The pan 300 is preferably disposable, however the pan 300 may be re-useable.

Further in FIG. 1C, a control panel 600 is coupled to the bottom 205 of the outer shell 200. The control panel 600 is configured to be between a first leg 208 and a second leg 209.

The control panel 600 has a display panel 601, a power control 602, a temperature up control 603 and a temperature down button 604. The display panel 601 is preferably a light emitting diode (LED) panel however other types of panels are hereby contemplated. The power control 602 is preferably a push button, however other types of controls are hereby contemplated. The temperature up control 603 is preferably a push button, however other types of controls are hereby contemplated. The temperature down control 604 is preferably a push button, however other types of controls are hereby contemplated.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An electric skillet for cooking food, the skillet comprising:
an outer shell, the outer shell having an outside, an inside and a rim;
one or more handles, the one or more handles being coupled to a middle of the outside of the outer shell;
an electrical port, the electrical port being coupled to substantially near a bottom of the outer shell;
a pan, the pan having an outside, an inside and a rim, wherein the pan being configured to be removably coupled to the inside of the outer shell; and
a top, the top having an outside, an edge and a top handle, wherein the top handle being coupled to the outside of the top, and wherein the edge of the top being removably coupled from the rim of the outer shell.

2. The skillet of claim 1, wherein the top further comprising:
a coupling device, the coupling device being coupled to the edge of the top, and wherein the coupling device being coupled to the rim of the top.

3. The skillet of claim 1, wherein the out shell being made of a cast iron material.

4. The skillet of claim 1, wherein the pan being made of a ceramic material.

5. The skillet of claim 1, wherein the skillet having a shape being oblong.

6. The skillet of claim 1, wherein the skillet having a shape being square.

7. The skillet of claim 1, wherein the skillet having a height being between four and five (4-5) inches.

8. The skillet of claim 1, wherein the skillet having a length being sixteen (16) inches.

9. The skillet of claim 1, wherein the skillet having a depth being twelve (12) inches.

10. The skillet of claim 1, wherein the handles being made of a heat-resistant plastic material.

11. The skillet of claim 1, wherein the top handle being made of a heat-resistant material.

12. The skillet of claim 1, wherein the pan being removable.

13. The skillet of claim 1, wherein the pan being disposable.
